(19) United States
(12) Patent Application Publication
(10) Pub. No.: US 2021/0160420 A1
(43) Pub. Date: May 27, 2021

(54) DETERMINATION DEVICE, CONTROL DEVICE, PHOTOGRAPHING DEVICE, DETERMINATION METHOD, AND PROGRAM

(71) Applicant: SZ DJI TECHNOLOGY CO., LTD., Shenzhen (CN)

(72) Inventors: Yoshinori NAGAYAMA, Tokyo (JP); Makoto TAKAMIYA, Tokyo (JP)

(21) Appl. No.: 17/169,100

(22) Filed: Feb. 5, 2021

Related U.S. Application Data
(63) Continuation of application No. PCT/CN2019/102018, filed on Aug. 22, 2019.

(30) Foreign Application Priority Data
Aug. 24, 2018 (JP) 2018-156825

(51) Int. Cl. H04N 5/232; G03B 13/36; G03B 3/02

(52) U.S. Cl. CPC H04N 5/23212; G03B 3/02; G03B 13/36

(57) ABSTRACT

A determination device includes a processor and a storage device storing instructions that, when executed by the processor, cause the processor to determine a first focus position of a focus frame in an image at a first time point, where the focus frame represents an area to focus on in the image captured by a photographing device, determine a first lens position of a focus lens of the photographing device at the first time point, determine a second lens position of the focus lens at a second time point later than the first time point, and determine a second focus position of the focus frame in the image at the second time point according to the first focus position, the first lens position, and the second lens position.

### CROSS-REFERENCE TO RELATED APPLICATIONS

This application is a continuation of International Application No. PCT/CN2019/102018, filed Aug. 22, 2019, which claims priority to Japanese Application No. 2018-156825, filed Aug. 24, 2018, the entire contents of both of which are incorporated herein by reference.

### TECHNICAL FIELD

The present disclosure relates to a determination device, a control device, a photographing device, a determination method and a program.

### BACKGROUND

Patent Document 1 discloses calculating an autofocus (AF) evaluation value indicating a focus state of an imaging optical system according to a change of at least one of an imaging magnification or a size of a shooting target in an image, i.e., a magnification change, and the image, and driving the imaging optical system according to the AF evaluation value.

Patent Document 1: International Publication No. 2013/054797.

The problem of the magnification change caused by a position change of a focus lens needs to be solved.

### SUMMARY

In accordance with the disclosure, there is provided a determination device including a processor and a storage device storing instructions that, when executed by the processor, cause the processor to determine a first focus position of a focus frame in an image at a first time point, where the focus frame represents an area to focus on in the image captured by a photographing device, determine a first lens position of a focus lens of the photographing device at the first time point, determine a second lens position of the focus lens at a second time point later than the first time point, and determine a second focus position of the focus frame in the image at the second time point according to the first focus position, the first lens position, and the second lens position.

Also in accordance with the disclosure, there is provided a control device that includes the determination device, where the instructions further cause the processor to control a position of the focus lens according to a focusing state within the focus frame at a determined position in the image.

Also in accordance with the disclosure, there is provided a photographing device comprising a focus lens and the control device.

Also in accordance with the disclosure, there is provided a determination method that includes determining a first focus position of a focus frame in an image at a first time point, where the focus frame represents an area to focus on in the image captured by a photographing device, determining a first lens position of a focus lens of the photographing device at the first time point, determining a second lens position of the focus lens at a second time point later than the first time point, and determining a second focus position of the focus frame in the image at the second time point according to the first focus position, the first lens position, and the second lens position.

Also in accordance with the disclosure, there is provided a non-transitory computer-readable storage medium storing a program that, when executed by a computer, causes the computer to determine a first focus position of a focus frame in an image at a first time point, where the focus frame represents an area to focus on in the image captured by a photographing device, determine a first lens position of a focus lens of the photographing device at the first time point, determine a second lens position of the focus lens at a second time point later than the first time point, and determine a second focus position of the focus frame in the image at the second time point according to the first focus position, the first lens position, and the second lens position.

### BRIEF DESCRIPTION OF THE DRAWINGS

FIG. 1 is a schematic perspective view of a photographing device according to an embodiment of the disclosure.

FIG. 2 is a diagram showing functional blocks of a photographing device according to an embodiment of the disclosure.

FIG. 3 is a diagram for explaining an influence of a change in image magnification on an image according to an embodiment of the disclosure.

FIG. 4 is a diagram for explaining another influence of a change in image magnification on an image according to embodiment of the disclosure.

FIG. 5 is a diagram showing a relationship between a focus lens position and an image magnification coefficient according to an embodiment of the disclosure.

FIG. 6 is a diagram for explaining a method of determining a position of a focus frame according to an embodiment of the disclosure.

FIG. 7 is a flowchart of a process for determining a position of a focus frame according to an embodiment of the disclosure.

FIG. 8 is a diagram of a hardware configuration according to an embodiment of the disclosure.

### REFERENCE NUMERALS

100—Photographing Device 102—Photographing Unit 110—Imaging Controller 112—Ascertaining Circuit 114—Determination Circuit 116—Focusing Controller 118—Display Controller 120—Image Sensor 130—Memory 160—Display 162—Instruction Circuit 200—Lens Unit 210—Focus Lens 211—Zoom Lens 212—Lens Driver 213—Lens Driver 214—Position Sensor 215—Position Sensor 220—Lens Controller 240—Memory 400—Shooting Target 500—Image 600—Focus Frame 1200—Computer 1210—Host Controller 1212—CPU 1214—RAM 1220—Input/Output Controller 1222—Communication Interface 1230—ROM

### DETAILED DESCRIPTION OF THE EMBODIMENTS

The technical solutions in the example embodiments of the present disclosure will be described clearly with reference to the accompanying drawings. The described embodiments are only some of the embodiments of the present disclosure, rather than all the embodiments. Based on the embodiments of the present disclosure, all other embodiments obtained by a person of ordinary skill in the art without creative efforts shall fall within the scope of the present disclosure.

Various embodiments of the present disclosure are described with reference to flowcharts and block diagrams. A block may represent a stage of a process of performing operations or a “unit” of a device that performs operations. The specific stages and “units” can be implemented by programmable circuits and/or processors. A “unit” can also include a hardware assembly. A dedicated circuit may include a digital and/or an analog circuit, or may include an integrated circuit (IC) and/or a discrete circuit. A programmable circuit may include a reconfigurable circuit. The reconfigurable circuit may include a circuit with a logic operation such as logic AND, logic OR, logic XOR, logic NAND, logic NOR, or another logic operation, a flip-flop, a register, a field programmable gate array (FPGA), a programmable logic array (PLA)), or another memory component.

The computer-readable medium may include any tangible device that can store instructions to be executed by a suitable device. As a result, the computer-readable medium with instructions stored is provided with a product including instructions that can be executed to create means for performing operations specified by the flowchart or the block diagram. The computer-readable medium may include electronic storage media, magnetic storage media, optical storage media, electromagnetic storage media, semiconductor storage media, or the like. As a more specific example of the computer-readable medium, it may include a Floppy® disk, a soft disk, a hard disk, a random-access memory (RAM), a read-only memory (ROM), an erasable programmable read-only memory (EPROM or a flash memory), an electrically erasable programmable read-only memory (EEPROM), a static random access memory (SRAM), a compact disc read-only memory (CD-ROM), a digital versatile disc (DVD), a Blu-ray® disc, a memory stick, or an integrated circuit card, etc.

The computer-readable instructions may include any one of source code or object code described in any combination of one or more programming languages. The source code or object code can include a programming language such as assembly instructions, instruction set architecture (ISA) instructions, machine instructions, machine-related instructions, microcode, firmware instructions, status setting data, or object-oriented programming languages such as Smalltalk, JAVA (registered trademark), C++, etc., or “C” programming language or similar programming languages. The computer-readable instructions may be provided locally or via a wide area network (WAN) such as a local area network (LAN) or an internet to a processor or a programmable circuit of a general-purpose computer, a special-purpose computer, or other programmable data processing device. The processor or programmable circuit can execute computer-readable instructions to create means for performing the operations specified in the flowchart or block diagram. Examples of processors include computer processors, processing units, microprocessors, digital signal processors, controllers, microcontrollers, and so on.

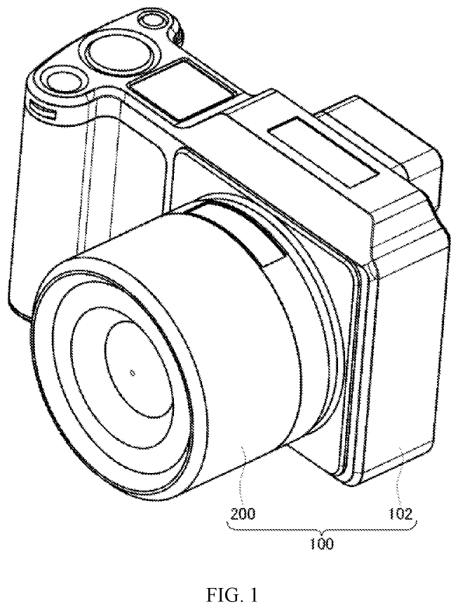

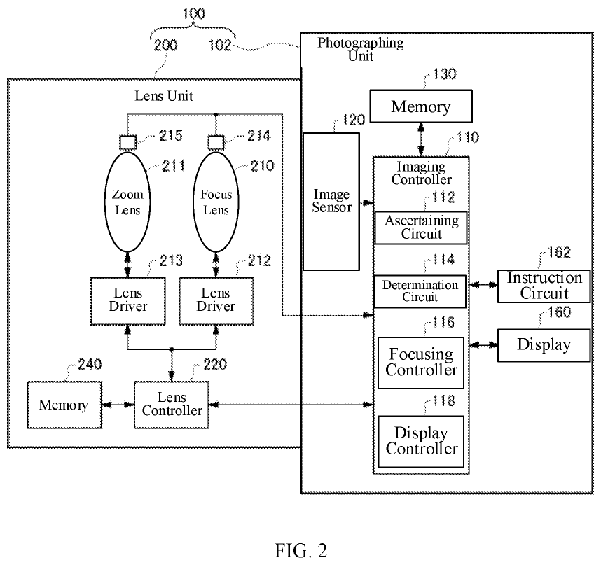

FIG. 1 is a schematic perspective view of a photographing device 100 according to an embodiment of the disclosure. FIG. 2 is a diagram showing functional blocks of the photographing device 100 as shown in FIG. 1.

The photographing device 100 includes a photographing unit 102 and a lens unit 200. The photographing unit 102 includes an image sensor 120, an imaging controller 110, and a memory 130. The image sensor 120 may include CCD or CMOS. The image sensor 120 shoots optical images formed through a zoom lens 211 or a focus lens 210, and outputs the shot images to the imaging controller 110. The imaging controller 110 may be constituted by a microprocessor such as a CPU or an MPU, a microcontroller such as an MCU, or the like. The memory 130 may be a computer-readable recording medium, and may include at least one of an SRAM, a DRAM, an EPROM, an EEPROM, or a flash memory such as a USB memory. The memory 130 stores programs that the imaging controller 110 uses to control the image sensor 120 and the like. The memory 130 may be provided inside a housing of the photographing device 100. The memory 130 may be configured to be detachable from the housing of the photographing device 100.

The photographing unit 102 further includes an instruction circuit 162 and a display 160. The instruction circuit 162 can include a user interface that accepts instructions to the photographing device 100 from the user. The display 160 can display images captured by the image sensor 120, various setting information of the photographing device 100, and/or the like. The display 160 may include a touch panel.

The lens unit 200 includes a focus lens 210, a zoom lens 211, a lens driver 212, a lens driver 213, and a lens controller 220. The focus lens 210 and the zoom lens 211 may include at least one lens. At least a part of or the entire focus lens 210 and zoom lens 211 are configured to be movable along an optical axis. The lens unit 200 may be an interchangeable lens that is provided to be detachable from the photographing unit 102. The lens driver 212 moves at least a part of or the entire focus lens 210 along the optical axis through a mechanism member such as a cam ring or a guide shaft. The lens driver 213 moves at least a part of or the entire zoom lens 211 along the optical axis through a mechanism member such as a cam ring or a guide shaft. The lens controller 220 drives at least one of the lens driver 212 or the lens driver 213 according to a lens control command from the photographing unit 102, and moves at least one of the focus lens 210 or the zoom lens 211 along the optical axis through a mechanism member in order to perform at least one of a zoom action or a focus action. The lens control command may be a zoom control command or a focus control command.

The lens unit 200 further includes a memory 240, a position sensor 214, and a position sensor 215. The memory 240 stores control values of the focus lens 210 and the zoom lens 211 that are moved via the lens driver 212 and the lens driver 213. The memory 240 may include at least one of an SRAM, a DRAM, an EPROM, an EEPROM, or a flash memory such as a USB memory. The position sensor 214 detects a position of the focus lens 210. The position sensor 214 can detect a current focus position. The position sensor 215 detects a position of the zoom lens 211. The position sensor 215 can detect a current zoom position of the zoom lens 211.

Generally, a lens system is designed so that an image magnification does not change as the position of the focus lens 210 changes. However, when the lens system is designed with priority given to image quality or a miniaturization of the lens system, for example, the image magnification may change as the position of the focus lens 210 changes.

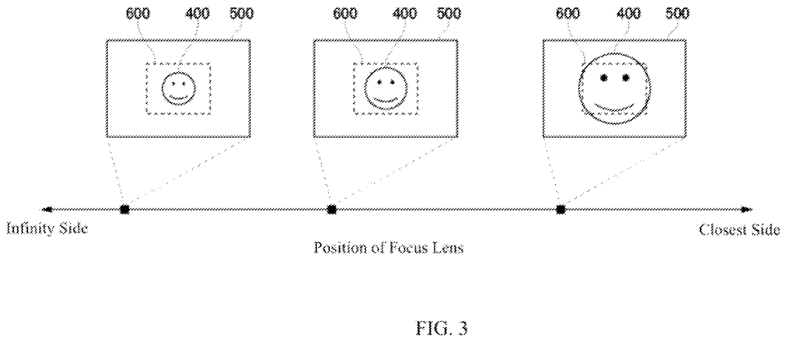

As shown in FIG. 3, according to optical characteristics of the lens system, there are scenarios where a size of a shooting target 400 in an image 500 changes because of a change in the position of the focus lens 210. For example, the size of the shooting target 400 in the image 500 when the focus lens 210 is at a closest side may be larger than the size of the shooting target 400 in the image 500 when the focus lens 210 is at an infinity side. According to the optical characteristics of the lens system, the size of the shooting target 400 in the image 500 when the focus lens 210 is at the closest side may be smaller than the size of the shooting target 400 in the image 500 when the focus lens 210 is at the infinity side. Because of a change in image magnification (image magnification change), a proportion of the shooting target 400 in a focus frame 600 changes.

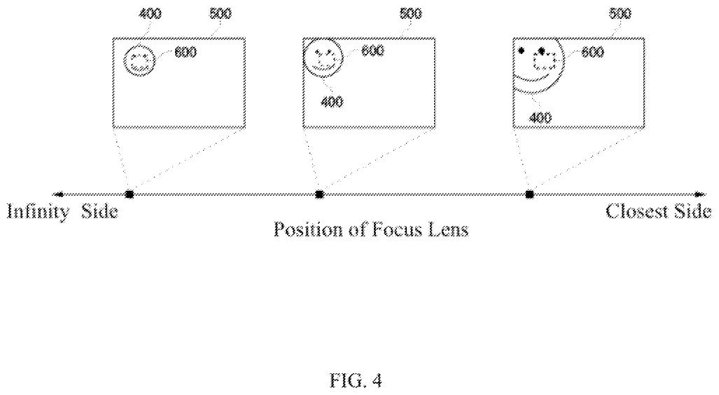

A shooting target that is farther from a center of the image is affected more from the change in image magnification. For example, as shown in FIG. 4, when the shooting target 400 deviates from a center of the image 500, the shooting target 400 may move within the image 500 with the change in image magnification. As a result, the shooting target 400 deviates from the focus frame 600. Therefore, when the photographing device 100 adjusts the position of the focus lens according to a focusing state in the focus frame 600, it may be possible to not focus on the shooting target 400 with high accuracy.

Therefore, the photographing device 100 of the present disclosure adjusts the position of the focus frame 600 in the image 500 in consideration of the image magnification change accompanying the position change of the focus lens 210. Therefore, the influence of changes in image magnification can be reduced.

The imaging controller 110 includes an ascertaining circuit 112, a determination circuit 114, a focusing controller 116, and a display controller 118. The ascertaining circuit 112 determines a position of the focus frame in the image at a first time point, and the focus frame represents an area to focus on in the image captured by the photographing device 100. The ascertaining circuit 112 may also determine a position of a center of the focus frame in a coordinate system predetermined with respect to the image captured by the photographing device 100. The position of the focus frame in the image at the first time point is also referred to as a “first focus position.”

The position of the focus frame before an adjustment performed with the change in the position of the focus lens 210 may be a predetermined position in the image captured by the photographing device 100. The position of the focus frame may be a center area within the image. The position of the focus frame may be a position specified by the user through the display 160 at the image captured by the photographing device 100. The size of the focus frame before the adjustment performed with the change in the position of the focus lens 210 may be a predetermined size. The size of the focus frame may be determined according to a size of a shooting target specified by the user through the display 160 at the image captured by the photographing device 100.

The ascertaining circuit 112 determines a position of the focus lens 210 of the photographing device 100 at the first time point. The position of the focus lens 210 at the first time point is also referred to as a “first lens position.” The ascertaining circuit 112 further determines a position of the focus lens 210 at a second time point later than the first time point. The position of the focus lens 210 at the second time point is also referred to as a “second lens position.” The ascertaining circuit 112 is an example of a first ascertaining circuit, a second ascertaining circuit, or a third ascertaining circuit. The ascertaining circuit 112 may determine the position of the focus lens 210 at the first time point and the second time point according to a focus control command for moving the focus lens 210. The ascertaining circuit 112 may determine the position of the focus lens 210 at the second time point according to a focus control command indicating the position where the focus lens should be located at the second time point.

The determination circuit 114 may determine a position of the focus frame at the second time point according to positions of the focus frame and the focus lens at the first time point and a position of the focus lens at the second time point. The position of the focus frame in the image at the second time point is also referred to as a “second focus position.” The determination circuit 114 may determine a ratio of an image magnification at the first time point to an image magnification at the second time point according to the positions of the focus lens at the first time point and the second time point. The image magnification at the first time point is also referred to as a “first image magnification,” the image magnification at the second time point is also referred to as a “second image magnification,” and the ratio of the image magnification at the first time point to the image magnification at the second time point is also referred to as a “magnification ratio.” The image magnification may be a ratio of a size (height) of the image formed at the image sensor 120 to a size (height) of an actual shooting target.

The determination circuit 114 may determine the position of the focus frame at the second time point according to the position of the focus frame at the first time point and the ratio of the image magnification at the first time point to the image magnification at the second time point. The determination circuit 114 may further determine a size of the focus frame at the second time point according to a size of the focus frame at the first time point and the ratio of the image magnification at the first time point to the image magnification at the second time point.

The determination circuit 114 may derive an image magnification coefficient K1 at the first time point and an image magnification coefficient K2 at the second time point according to a predetermined relationship between the position of the focus lens 210 and an image magnification coefficient Kn. This relationship can be predetermined according to the optical characteristics of the lens system.

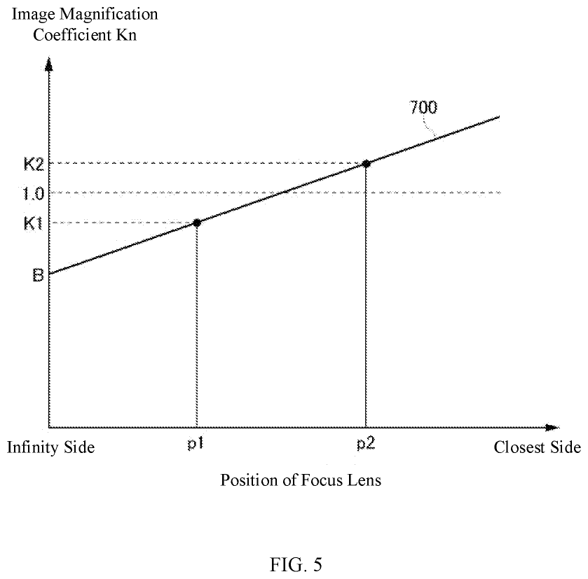

As shown in FIG. 5, the determination circuit 114 may derive the image magnification coefficient Kn corresponding to the position of the focus lens 210 according to a function 700 predetermined according to the optical characteristics of the lens system. For example, the function 700 may be determined by Kn=Axpn+B. A and B are coefficients determined according to the optical characteristics of the lens system, and pn denotes the position of the focus lens 210. In an example shown in FIG. 5, a relationship between the focus lens 210 and the image magnification coefficient Kn is determined by using a linear approximation method. However, according to the optical characteristics of the lens system, the relationship between the focus lens 210 and the image magnification coefficient Kn can be determined by a LOG curve or a Gaussian curve.

The ascertaining circuit 112 determines the position of the focus lens 210 at the first time point as p1 and determines the position of the focus lens 210 at the second time point as p2. In this scenario, the determination circuit 114 determines the image magnification coefficient K1 at the first time point as Axp1+B. Further, the determination circuit 114 determines the image magnification coefficient K2 at the second time point as Axp2+B. The determination circuit 114 may determine the position of the focus frame at the second time point according to the image magnification coefficient K1 at the first time point, the image magnification coefficient K2 and the second time point, and the position of the focus frame at the first time point.

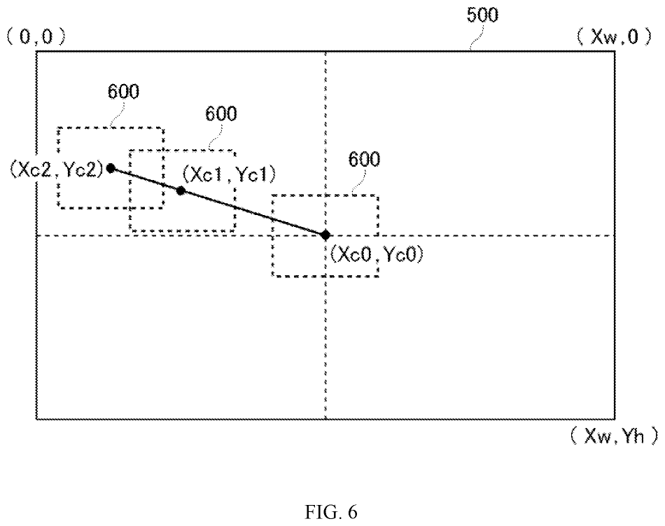

As shown in FIG. 6, coordinates of the center of the image 500 are (Xc0, Yc0). The coordinates of the center of the focus frame at the first time point are (Xc1, Yc1). In this scenario, the determination circuit 114 determines the coordinates (Xc2, Yc2) of the center of the focus frame at the second time point as (K2/K1x(Xc1−Xc0)+Xc, K2/K1x(Yc1−Yc0)+Yc).

The ascertaining circuit 112 may determine the size of the focus frame at the second time point according to the size of the focus frame at the first time point, the image magnification coefficient K1, and the image magnification coefficient K2. The ascertaining circuit 112 can determine vertical and horizontal lengths of the focus frame at the second time point by multiplying vertical and horizontal lengths, respectively, of the focus frame at the first time point by K2/K1.

Further, the determination circuit 114 may determine the position of the focus frame corresponding to the position of the focus lens 210 by referring to a table that is stored in the memory 130 in advance and correlates the position of the focus lens 210 with the position of the focus frame with a predetermined size. The table stored in the memory 130 is an example of information indicating a correspondence relationship between the position of the focus lens 210 and the position of the focus frame. The memory 130 is an example of a storage device. The table can be generated according to actual measured values. For example, the table may be generated according to measurement results of the positions and sizes of the shooting target at predetermined positions in the image and measured during the movement of the focus lens 210.

The focusing controller 116 may control the position of the focus lens 210 according to a focusing state of a portion of the image captured by the photographing device 100 in the focus frame, where the portion of the image is at the position determined by the determination circuit 114. The focusing controller 116 may control the position of the focus lens 210 according to a contrast evaluation value within the focus frame in the image, so that the shooting target within the focus frame is focused. The focusing controller 116 may control the position of the focus lens 210 so that the contrast evaluation value within the focus frame is greater than or equal to a predetermined threshold.

The display controller 118 may control the position of the focus frame superimposed at the image captured by the photographing device 100 and displayed at the display 160 according to the position of the focus frame determined by the determination circuit 114. The display controller 118 may superimpose the focus frame at the image and display the focus frame at the display 160 according to the movement of the focus lens 210.

The display controller 118 can enlarge and display the image within the focus frame at the display 160. The display controller 118 may superimpose the focus frame at the image captured by the photographing device 100 and display it at the display 160, and further enlarge and display the image within the focus frame at a predetermined area of the display 160. As a result, when the image within the focus frame is enlarged and displayed at the display 160, it is possible to suppress a change in the position of the shooting target in the focus frame accompanying the change in image magnification.

The photographing device 100 has an autofocus tracking (automatic tracking) function. In a scenario where the photographing device 100 performs the autofocus tracking, the photographing device 100 moves the focus frame within the image according to the movement of the shooting target. Therefore, the determination circuit 114 can determine the position of the focus frame according to a movement direction and a movement amount of the focus frame of the autofocus tracking, and a movement direction and a movement amount of the focus frame accompanying the change in the image magnification of the focus lens 210. For example, in a scenario where the shooting target moves away from the image sensor 120 in an optical axis direction, the image sensor 210 moves to the closest side. The determination circuit 114 may determine the position of the focus frame in consideration of the movement of the focus lens 210, so that the focus frame moves to the center of the image.

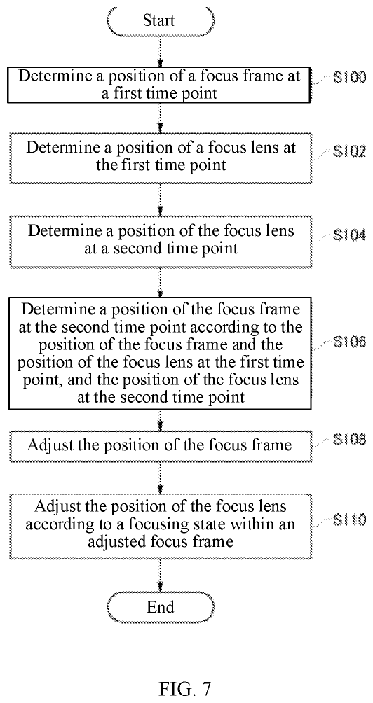

FIG. 7 is a flowchart of a process for determining a position of a focus frame according to an embodiment of the disclosure.

At a first time point, the display controller 118 displays the focus frame on the display 160 at a position specified by a user. The ascertaining circuit 112 determines a position of the focus frame at the first time point (S100). The ascertaining circuit 112 determines a position of the focus lens 210 at the first time point (S102). The focusing controller 116 adjusts the position of the focus lens 210 according to a focusing state of a portion of an image within the focus frame. The focusing controller 116 performs AF processing such as a contrast detection AF processing.

The ascertaining circuit 112 determines a position of the focus lens 210 at a second time point later than the first time point (S104). The ascertaining circuit 112 may determine the position of the focus lens 210 at the second time point according to a focusing control command indicating a position where the focus lens 210 should be located at the second time point.

The determination circuit 114 determines a position of the focus frame at the second time point according to the position of the focus frame and the position of the focus lens 210 at the first time point, and the position of the focus lens 210 at the second time point (S106). The determination circuit 114 may determine the position of the focus frame at the second time point according to an image magnification coefficient K1 at the first time point, an image magnification coefficient K2 at the second time point, and the position of the focus frame at the first time point.

The display controller 118 adjusts the position of the focus frame according to the position determined by the determination circuit 114, and displays the focus frame at the display 160 (S108). When the image within the focus frame is enlarged and displayed at the display 160, the display controller 118 may change an area of the image displayed at the display 160 according to the position of the focus frame.

The focusing controller 116 adjusts the position of the focus lens 210 according to the focusing state within an adjusted focus frame (S110).

As described above, in the embodiments of the disclosure, the photographing device 100 adjusts the position of the focus frame in the image taking into consideration the change in the image magnification accompanying the change in the position of the focus lens 210, which can reduce the influence of changes in image magnification. For example, it is possible to suppress a change in the position of the shooting target within the focus frame caused by the change in the image magnification, and suppress a decrease in the focusing accuracy of a desired shooting target. When the image in the focus frame is enlarged and displayed, it is possible to suppress a movement of the shooting target within the focus frame accompanying the change in the image magnification.

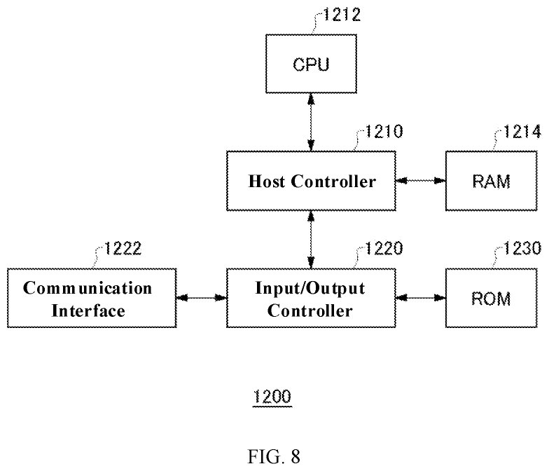

FIG. 8 shows an example of a computer 1200 that may embody one or more aspects of the present disclosure. The program installed on the computer 1200 can make the computer 1200 function as an operation associated with a device according to the embodiments of the present disclosure or one or more “units” of the device. In some embodiments, the program can cause the computer 1200 to perform the operation or the one or more “units.” The program enables the computer 1200 to execute a process or stages of the process consistent with embodiments of the present disclosure. The program can be executed by a CPU 1212 to cause the computer 1200 to perform a method consistent with the disclosure, such as executing specific operations associated with some or all of the blocks in the flowcharts or block diagrams described in this disclosure.

The computer 1200 of this disclosure includes the CPU 1212 and a RAM 1214, which are connected to each other through a host controller 1210. The computer 1200 further includes a communication interface 1222, an input/output unit, which is connected to the host controller 1210 through an input/output controller 1220. The computer 1200 also includes a ROM 1230. The CPU 1212 operates in accordance with programs stored in the ROM 1230 and RAM 1214 to control each unit.

The communication interface 1222 communicates with other electronic devices through a network. A hard disk drive can store programs and data used by the CPU 1212 of the computer 1200. The ROM 1230 stores a bootloader executed by the computer 1200 during operation, and/or a program dependent on the hardware of the computer 1200. The program is provided through a computer-readable medium such as a CR-ROM, a USB memory, or an IC card, or a network. The program is installed in the RAM 1214 or the ROM 1230, which are examples of computer-readable medium, and is executed by the CPU 1212. The information processing described in the programs is read by the computer 1200 and causes cooperation between the program and the various types of hardware resources described above. The device or method may be constituted by realizing the operation or processing of information with the use of the computer 1200.

For example, when a communication is performed between the computer 1200 and an external device, the CPU 1212 can execute a communication program loaded in the RAM 1214, and based on the processing described in the communication program, instruct the communication interface 1222 to perform communication processing. Under the control of the CPU 1212, the communication interface 1222 reads transmission data stored in a transmission buffer provided in a recording medium such as the RAM 1214 or a USB memory, and transmits the read transmission data to a network or writes received data received from the network in a receiving buffer provided in a recording medium.

Further, the CPU 1212 can make the RAM 1214 read all or required parts of files or databases stored in an external recording medium such as a USB memory, and perform various types of processing on the data of the RAM 1214. Then, the CPU 1212 can write the processed data back to the external recording medium.

Various types of information such as various types of programs, data, tables, and databases can be stored in the recording medium, and the information can be processed. For the data read from the RAM 1214, the CPU 1212 can execute various types of operations, information processing, conditional determination, conditional transfer, unconditional transfer, or information retrieval/replacement specified by the instruction sequence of the program described in the disclosure, and write the result back to the RAM 1214. In addition, the CPU 1212 can retrieve information in files, databases, or the like in the recording medium. For example, when a plurality of entries having attribute values of first attributes respectively associated with attribute values of second attributes are stored in the recording medium, the CPU 1212 may retrieve an entry that matches the condition that specifies the attribute value of the first attribute from the plurality of entries and read the attribute value of the second attribute stored in the entry to obtain the attribute value of the second attribute associated with the first attribute meeting a preset condition.

The programs or software modules described above may be stored at the computer 1200 or at a computer-readable storage medium near the computer 1200. In addition, a recording medium such as a hard disk or a RAM provided in a server system connected to a dedicated communication network or the internet can be used as a computer-readable storage medium to provide the program to the computer 1200 through the network.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the scope of the present disclosure.

The execution order of the actions, sequences, steps, and stages of the devices, systems, programs, and methods shown in the claims, specification, and drawings of the disclosure, can be implemented in any order as long as there is no special indication such as “before,” “in advance,” etc., and the output of the previous processing is not used in the subsequent processing. Regarding the operation procedures in the claims, the specification, and the drawings of the disclosure, the description is made using “first,” “next,” etc. for convenience, but it does not mean that the operations must be implemented in this order.

What is claimed is:

1. A determination device comprising:
a processor; and
a storage device storing instructions that, when executed by the processor, cause the processor to:
determine a first focus position of a focus frame in an image at a first time point, the focus frame representing an area to focus on in the image captured by a photographing device;
determine a first lens position of a focus lens of the photographing device at the first time point;
determine a second lens position of the focus lens at a second time point later than the first time point; and
determine a second focus position of the focus frame in the image at the second time point according to the first focus position, the first lens position, and the second lens position.

2. The determination device of claim 1, wherein the instructions further cause the processor to:
determine a magnification ratio of an image magnification at the first time point to an image magnification at the second time point according to the first lens position and the second lens position; and
determine the second focus position according to the first focus position and the magnification ratio.

3. The determination device of claim 2, wherein the photographing device performs an autofocus tracking, moving the focus frame within the image according to a movement of a shooting target.

4. The determination device of claim 3, wherein the instructions further cause the processor to:
determine the second focus position according to the first focus position, the magnification ratio, and a movement direction and a movement amount of the focus frame of the autofocus tracking.

5. The determination device of claim 4, wherein the instructions further cause the processor to:
determine a first image magnification coefficient at the first time point and a second image magnification coefficient at the second time point according to a predetermined relationship between the positions of the focus lens and image magnification coefficients; and
determine the magnification ration according to the first image magnification coefficient and the second image magnification coefficient.

6. The determination device of claim 2, wherein the instructions further cause the processor to:
determine a size of the focus frame at the second time point according to a size of the focus frame at the first time point and the magnification ratio.

7. The determination device of claim 1, wherein the instructions further cause the processor to:
determine the second focus position according to a correspondence relationship between positions of the focus lens and positions of the focus frame in the image.

8. A control device comprising:
the determination device of claim 1, wherein:
the instructions further cause the processor to control a position of the focus lens according to a focusing state within the focus frame at a determined position in the image.

9. The control device of claim 8, wherein the instructions further cause the processor to:
control a superimposition position of the focus frame superimposed at the image captured by the photographing device and displayed at a display, according to the determined position of the focus frame in the image.

10. A photographing device comprising:
a focus lens; and
the control device of claim 8.

11. A determination method comprising:
determining a first focus position of a focus frame in an image at a first time point, the focus frame representing an area to focus on in the image captured by a photographing device;
determining a first lens position of a focus lens of the photographing device at the first time point;
determining a second lens position of the focus lens at a second time point later than the first time point; and
determining a second focus position of the focus frame in the image at the second time point according to the first focus position, the first lens position, and the second lens position.

12. The determination method of claim 11, further comprising:
determining a magnification ratio of an image magnification at the first time point to an image magnification at the second time point according to the first lens position and the second lens position; and
determining the second focus position according to the first focus position and the magnification ratio.

13. The determination method of claim 12, further comprising:
performing an autofocus tracking, by the photographing device, moving the focus frame within the image according to a movement of a shooting target; and
determining the second focus position according to the first focus position, the magnification ratio, and a movement direction and a movement amount of the focus frame of the autofocus tracking.

14. The determination method of claim 13, further comprising:
determining a first image magnification coefficient at the first time point and a second image magnification coefficient at the second time point according to a predetermined relationship between the positions of the focus lens and image magnification coefficients; and
determining the magnification ration according to the first image magnification coefficient and the second image magnification coefficient.

15. The determination method of claim 12, further comprising:
determining a size of the focus frame at the second time point according to a size of the focus frame at the first time point and the magnification ratio.

16. The determination method of claim 11, further comprising:
determining the second focus position according to a correspondence relationship between positions of the focus lens and positions of the focus frame in the image.

17. A non-transitory computer-readable storage medium storing a program that, when executed by a computer, causes the computer to:
determine a first focus position of a focus frame in an image at a first time point, the focus frame representing an area to focus on in the image captured by a photographing device;
determine a first lens position of a focus lens of the photographing device at the first time point;
determine a second lens position of the focus lens at a second time point later than the first time point; and
determine a second focus position of the focus frame in the image at the second time point according to the first focus position, the first lens position, and the second lens position.

18. The storage medium of claim 17, wherein the program further causes the computer to:
determine a magnification ratio of an image magnification at the first time point to an image magnification at the second time point according to the first lens position and the second lens position; and
determine the second focus position according to the first focus position and the magnification ratio.

19. The storage medium of claim 18, wherein the program further causes the computer to:
determine a size of the focus frame at the second time point according to a size of the focus frame at the first time point and the magnification ratio.

20. The storage medium of claim 17, wherein the program further causes the computer to:
determine the second focus position according to a correspondence relationship between positions of the focus lens and positions of the focus frame in the image.
